(19) United States
(12) Patent Application Publication
(10) Pub. No.: US 2019/0138205 A1
(43) Pub. Date: May 9, 2019

(54) IMAGE DISPLAY METHOD OF A DUAL-SCREEN DEVICE, DUAL-SCREEN DEVICE, AND NON-TRANSITORY STORAGE MEDIUM

(71) Applicant: HISENSE MOBILE COMMUNICATIONS TECHNOLOGY CO., LTD., Qingdao (CN)

(72) Inventors: Jin WU, Qingdao (CN); Xiaofang ZHAO, Qingdao (CN); Yanwen YU, Qingdao (CN)

(21) Appl. No.: 16/140,377

(22) Filed: Sep. 24, 2018

(30) Foreign Application Priority Data
Nov. 9, 2017 (CN) 201711094544.9
Nov. 9, 2017 (CN) 201711096188.4
Aug. 31, 2018 (CN) PCT/CN2018/103582

(51) Int. Cl. G06F 3/0488; G06F 1/32; H04L 12/58

(52) U.S. Cl. CPC G06F 3/04886; H04L 51/24; G06F 1/3206

(57) ABSTRACT

The disclosure discloses an image display method of a dual-screen device, a dual-screen device and a computer readable non-transitory storage medium. The dual-screen device includes a first screen and a second screen which is an e-ink screen and arranged opposite to the first screen. The method includes: upon detecting a display instruction for displaying an image on the second screen, obtaining a target image currently being displayed on the first screen; and displaying the target image on the second screen.

### CROSS-REFERENCE TO RELATED APPLICATIONS

This application claims priority under 35 U.S.C. § 119 to International Application No. PCT/CN2018/103582, filed Aug. 31, 2018, Chinese Patent Application No. 201711096188.4, filed Nov. 9, 2017, and Chinese Patent Application No. 201711094544.9, filed on Nov. 9, 2017, all of which are hereby incorporated by reference in their entireties.

### FIELD

The disclosure relates to a mobile device, and particularly to an image display method of a dual-screen device, a dual-screen device, and a computer readable non-transitory storage medium.

### BACKGROUND

With the rapid development of the Internet technologies, the functions of the applications installed in a mobile device are also increasing. For example, an application for mobile payment can display a two-dimensional code (i.e. a QR code) to be scanned on a display screen of the mobile device, and a verifier can implement a mobile payment function by scanning this two-dimensional code. For another example, a two-dimensional code on a cinema ticket or a boarding pass can also be displayed on the mobile device, and the verifier can also implement a ticket verification function and the like by scanning this two-dimensional code. Sometimes these two-dimensional codes to be scanned need to be displayed on the display screen of the mobile device for a long time, so as to be still presented to the verifier in the case of waiting in line when a user performs the mobile payment or ticket verification by using the mobile device.

For this, the user often desires to set the display screen of the mobile device to an always-on state (i.e., until receiving a lock screen instruction, the mobile device can stay in an awake state even if no operation is received for an extended period of time), so that the display screen of the mobile device can display the two-dimensional codes for a long time. However, Since the display screen of the mobile device is often a liquid crystal display screen which displays an image only when a backlight source is illuminating it, setting of the display screen to the always-on state may cause too high power consumption of the mobile device. The user can also set the display screen of the mobile device to be illuminated for a preset time, and the liquid crystal screen turns off if the preset time expires. Then, when the verifier needs to scan the two-dimensional code, the mobile device is unlocked to illuminate the display screen of the mobile device. However, since the time of waiting in line is relatively long or unknown, the user needs to unlock the mobile device repeatedly to stay in the awake state, which makes the operation complicated.

### SUMMARY

Embodiments of the disclosure provide an image display method of a dual-screen device, a dual-screen device, and a computer readable non-transitory storage medium.

In an aspect, the embodiments of the disclosure provide an image display method of a dual-screen device including a first screen and a second screen which is an e-ink screen and arranged opposite to the first screen, and the method includes: upon detecting a display instruction for displaying an image on the second screen, obtaining a target image currently being displayed on the first screen; and displaying the target image on the second screen.

In another aspect, the embodiments of the disclosure provide a dual-screen device including a first screen, a second screen which is an e-ink screen and arranged opposite to the first screen, and a processor and a memory storing computer programs; wherein the processor is configured to execute the computer programs to: obtain a target image currently being displayed on the first screen upon detecting a display instruction for displaying an image on the second screen; and display the target image on the second screen.

In still another aspect, the embodiments of the disclosure provide a computer readable non-transitory storage medium including program codes, wherein the program codes are configured to enable a processor of the dual-screen device to execute operations of the image display method according to the embodiments of the disclosure when the program codes run on the processor.

### BRIEF DESCRIPTION OF THE DRAWINGS

In order to make the technical solutions according to the embodiments of the disclosure more apparent, the drawings to which a description of the embodiments refers will be briefly introduced below, and the drawings to be described below are merely illustrative of some of the embodiments of the disclosure, and those ordinarily skilled in the art can derive from these drawings other embodiments also encompassed by this application.

FIG. 1 shows a schematic flow diagram of an image display method of a dual-screen device according to the embodiments of the disclosure;

FIG. 2A shows a schematic flow diagram of another image display method of a dual-screen device according to the embodiments of the disclosure;

FIG. 2B shows a schematic flow diagram of a method for generating a display instruction according to a received preset display operation on the first screen, by a dual-screen device, according to the embodiments of the disclosure;

FIG. 2C shows a schematic diagram of a prompt message displayed by a dual-screen device after a screen capture operation according to the embodiments of the disclosure;

FIG. 2D shows a schematic diagram of an entry icon according to the embodiments of the disclosure;

FIG. 2E shows a schematic diagram of a target image displayed by a second screen in a lock screen state according to the embodiments of the disclosure;

FIG. 2F shows a schematic diagram of a page number indication icon according to the embodiments of the disclosure;

FIG. 3A shows a schematic structural diagram of an image display apparatus of a dual-screen device according to the embodiments of the disclosure;

FIG. 3B shows another schematic structural diagram of the image display apparatus of the dual-screen device according to the embodiments of the disclosure;

FIG. 4 shows a schematic structural diagram of a dual-screen device according to the embodiments of the disclosure.

### DETAILED DESCRIPTION

In order to make the objects, technical solutions, and advantages of the disclosure clearer, the embodiments of the disclosure will be described below in detail with reference to the accompanying drawings.

A dual-screen device according to the embodiments of the disclosure includes two screens which are arranged on two surfaces opposite to each other. And in the embodiments of the disclosure, these two display screens can be equivalent, such that, for example, both of the two display screens are provided with display and touch control functionality. Here, a first screen located on a front surface of the dual-screen device can be a liquid crystal display screen or an Organic Light-Emitting Diode (OLED) display screen, and a second screen located on a back surface of the dual-screen device can be an e-ink screen. The dual-screen device can be a mobile phone.

The inventors find that the display characteristic of the e-ink screen depends on reflected light rays rather than emitted light rays. Like plain paper, the e-ink screen can reflect light rays, which can ensure that the display content is displayed naturally under any light condition (not reflecting the light to create a glare, and can also be displayed under bright light). Thus, when a payment code or a ticket verification code to be scanned, is pushed by the liquid crystal screen of the dual-screen device to the e-ink screen and then displayed on the e-ink screen (for example, displayed in a current display page of the e-ink screen or displayed as a lock screen image when the e-ink screen is in a lock screen state) since the e-ink screen depends on the reflected light rays of the ambient environment to implement the display function, not only the power consumption of the dual-screen device can be reduced, but also there is no need to unlock the dual-screen device repeatedly to illuminate the screen.

FIG. 1 shows a flow chart of an image display method of a dual-screen device according to the embodiments of the disclosure, wherein the dual-screen device can include a first screen and a second screen which is an e-ink screen arranged opposite to the first screen. As illustrated in FIG. 1, the method includes the following operations.

Operation 101: upon detecting a display instruction for displaying an image on the second screen, obtaining a target image currently being displayed on the first screen.

In some embodiments, the display instruction is generated when a preset display operation on the first screen is received by the dual-screen device; or the display instruction is generated when a two-dimensional code or a bar code presented on the first screen is detected; or the display instruction is generated when it is detected that the first screen switches from an awake state to a screen-off state due to non-operation.

In some embodiments, the target image is an image that includes a two-dimensional code or a bar code, which needs to be displayed for an extended period of time; or an image that includes a character string (e.g., an address or a phone number, etc.) which needs to be displayed for an extended period of time.

Operation 102: displaying the target image on the second screen.

In some embodiments, when the display instruction for displaying an image on the second screen is detected, the dual-screen device further detects whether the second screen is in a lock screen state; and in response to the second screen being in the lock screen state, the dual-screen device displays the target image in a lock screen page of the second screen, for example, setting the target image as a lock screen image of the second screen.

If it is detected that the second screen is not in the lock screen state, the dual-screen device displays the target image in a current display page of the second screen and sets the target image as the lock screen image of the second screen, so that the second screen can display the target image for an extended period of time under the unlock state and the lock screen state.

In conclusion, the embodiments of the disclosure provide image display methods of a dual-screen device, where the dual-screen device can obtain a target image according to a detected display instruction and display the target image on a second screen. For example, when the second screen is in the lock screen state, the target image is displayed directly on a lock screen page of the second screen; and when the second screen is not in the lock screen state, the target image is displayed on a current display page of the second screen and the target image is set as a lock screen image of the second screen. Since the second screen can be an e-ink screen which can reflect the light rays, it can be ensured that the target image can be displayed naturally under any light condition, so that the power consumption of the dual-screen device is reduced effectively, and there is no need for a user to illuminate the first screen repeatedly, which allows the user to show the target image on the e-ink screen conveniently. In addition, most users are used to inputting instructions on the first screen and face the first screen. In order to scan the image showing on the first screen with a scanning device, the users need to manually move the mobile device to allow the image showing on the first screen to face the scanning device. The methods provided in this disclosure allow the image showing on the first screen to display on the second screen, thereby being scanned by the scanning device which is usually facing a side opposite the first screen. Therefore, there is no need for the users to manually move their mobile device to allow the scanning device to scan the image on the first screen. An instruction input on the first screen allows the mobile device to show the target image on the second screen to avoid repeated operations on the first screen, thereby making it easier for the user to show the target image to the scanning device.

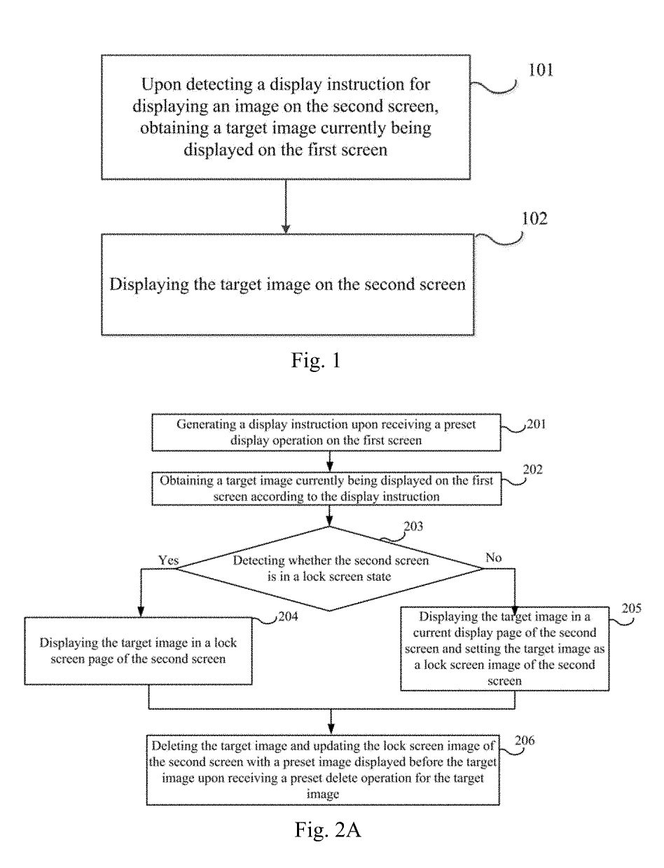

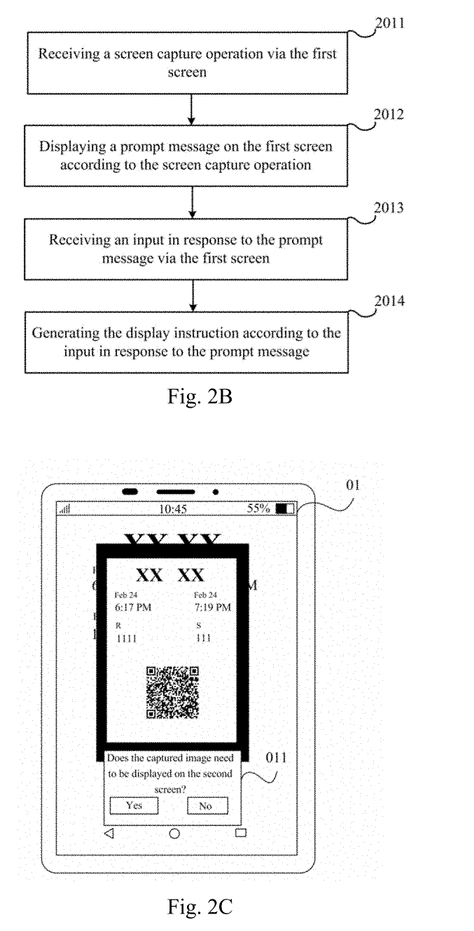

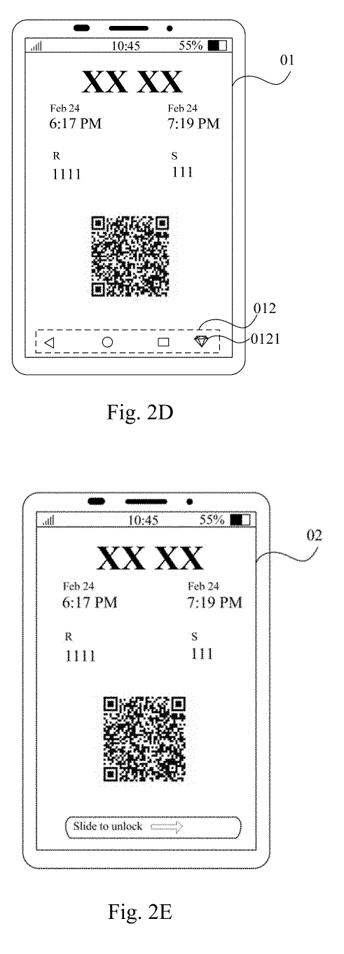

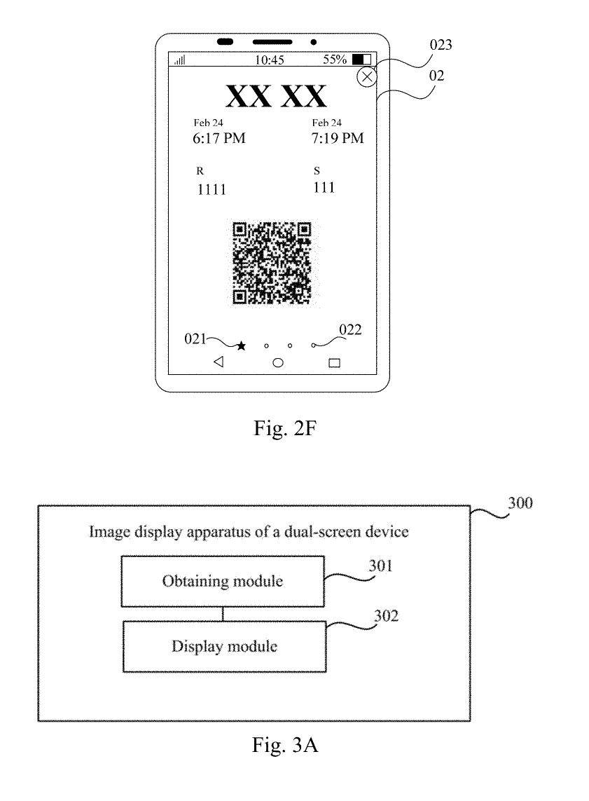

FIG. 2A shows a flow chart of another image display method of a dual-screen device according to some embodiments of the disclosure, wherein the dual-screen device can include a first screen and a second screen which is an e-ink screen arranged opposite from the first screen. As illustrated in FIG. 2A, the method includes the following operations.

Operation 201: generating a display instruction upon receiving a preset display operation on the first screen.

In some embodiments, as illustrated in FIG. 2B, the operation of generating by the dual-screen device the display instruction according to the received preset display operation on the first screen includes the following operations 2011 to 2014.

Operation 2011: receiving a screen capture operation via the first screen.

In some embodiments, when a user wants to capture content displayed on the first screen of the dual-screen device, a screen capture operation can be performed on the first screen. The screen capture operation is an operation of clicking a screen capture icon, or an operation of double-clicking or long pressing on a display screen, although other actions are also contemplated in the embodiments of the disclosure. And after receiving the screen capture operation via the first screen, the dual-screen device can capture an image displayed on the first screen.

Operation 2012: displaying a prompt message on the first screen according to the screen capture operation.

The dual-screen device can display the prompt message on the first screen after receiving the screen capture operation via the first screen, where the prompt message is used for asking the user whether the captured image needs to be displayed on the second screen.

For example, if the user clicks the screen capture icon on the first screen of the dual-screen device, then as illustrated in FIG. 2C, the dual-screen device can display the prompt message 011 on the first screen 01 according to the received screen capture operation, where the prompt message 011 can include a prompt text “Does the captured image need to be displayed on the second screen?”, a “Yes” icon and a “No” icon.

Operation 2013: receiving an input in response to the prompt message via the first screen.

When the user determines that the captured image needs to be displayed on the second screen under the indication of the prompt message, in response to the prompt message, an input (i.e. a display operation for showing an image on the second screen) is performed by the user on the first screen. For example, the user can click the “Yes” icon of the prompt message 011 on the first screen 01, and then the dual-screen device can receive the display operation for showing an image on the second screen via the first screen 01.

In some embodiments, an entry icon is displayed on the first screen of the dual-screen device, and the display operation is an operation (e.g., a clicking operation or a long pressing operation or the like) performed for the entry icon.

For example, FIG. 2D shows a schematic diagram of the entry icon according to some embodiments of the disclosure. As illustrated in FIG. 2D, a menu bar 012 is displayed at a bottom of the first screen 01 of the dual-screen device, the entry icon 0121 is displayed in the menu bar 012, and a return icon and a home page icon and the like can also be included in the menu bar 012.

It shall be noted that the display operation for displaying an image on the second screen can also be an operation of long pressing a blank area of the first screen, or it can also be an operation of pressing specified physical button(s) (e.g., simultaneously pressing a power button and a volume button). That is, the implementation of the display operation is not limited to the embodiments explicitly described in the disclosure.

Operation 2014: generating the display instruction according to the input in response to the prompt message.

That is, the dual-screen device can generate the display instruction according to the received display operation, where the display instruction is used for initiating the obtaining of a target image currently being displayed on the first screen.

It shall be noted that, in the embodiments of the disclosure, when the dual-screen device detects the screen capture operation for the first screen, it can detect whether a two-dimensional code or a bar code is included in the captured image; and when the dual-screen device detects that the two-dimensional code or the bar code is included in the captured image, the dual-screen device can generate the display instruction automatically, so that the dual-screen device can display the target image on the second screen according to the display instruction, to improve the flexibility of displaying the target image.

In some embodiments, when the dual-screen device detects that the first screen switches from an awake state to a screen-off state due to non-operation, the dual-screen device can generate the display instruction, so that the dual-screen device can display the target image on the second screen according to the display instruction. At this time, the user can view the target image directly via the second screen without awakening the first screen to input further instructions, which simplifies the operation of the user effectively.

In some embodiments, when detecting that the first screen switches from the awake state to the screen-off state due to non-operation, the dual-screen device can determine whether there is a target image, which includes a two-dimensional code or a bar code, presented on the first screen or not, and when the two-dimensional code or the bar code is presented on the first screen, the dual-screen device generates the display instruction.

Operation 202: obtaining a target image currently being displayed on the first screen according to the display instruction.

In some embodiments, the target image includes a two-dimensional code or a bar code, which needs to be displayed for a long time, or includes a character string (e.g., an address or a phone number, etc.) which needs to be displayed for a long time. That is, the content included in the target image is not limited to the embodiments explicitly described in the disclosure.

Here, a memory in the dual-screen device can include a first memory storing the image(s) displayed on the first screen, a second memory storing the image(s) displayed on the second screen, and a shared memory, where the image(s) stored in the shared memory can be displayed on both the first screen and the second screen. After the dual-screen device captures the image displayed on the first screen according to the screen capture operation, the captured image can be stored into the shared memory. Thus the dual-screen device can read the captured image directly from the shared memory and display the captured image according to the display instruction.

In some embodiments, the dual-screen device can monitor for the display instruction in real time via a preset monitoring function, and if the display instruction is detected by the dual-screen device, the dual-screen device can obtain a binary code corresponding to the target image directly and push the binary code to the second screen to display. Or, the dual-screen device can obtain a bitmap file of the target image when detecting the display instruction, and store the bitmap file into the shared memory (e.g., a stack memory of codes) or a system memory, and then read the bitmap file of the target image from the shared memory or the system memory and display it on the second screen.

In some embodiments, in the operation 201 above, if the display instruction is generated by the trigger of the screen capture operation, the dual-screen device can obtain an image displayed on the first screen and captured in advance directly according to the display instruction.

For example, after the dual-screen device receives an operation of clicking the “Yes” icon as illustrated in FIG. 2C, an image displayed on the first screen 01 and captured by the dual-screen device in advance is obtained.

In the above operation 201, if the display instruction is not generated by the trigger of the screen capture operation, the dual-screen device can obtain the target image by capturing the image currently being displayed on the first screen directly.

For example, after the dual-screen device receives an operation of clicking the entry icon 0121 as illustrated in FIG. 2D, the dual-screen device can capture the target image currently being displayed on the first screen 01 directly.

It shall be noted that, in some embodiments of the disclosure, besides obtaining the target image currently being displayed on the first screen, the dual-screen device can obtain a second target image currently being displayed on the second screen. In some embodiments, when the dual-screen device receives a second preset display operation via the second screen, or when the dual-screen device detects a two-dimensional code or a bar code presented on the second screen, the dual-screen device can generate a second display instruction used for indicating the obtaining of the second target image currently being displayed on the second screen. And after detecting the second display instruction, the dual-screen device can determine the second target image as the lock screen image of the second screen, so as to ensure that the second screen can continue to display the second target image after the second screen is locked.

Operation 203: detecting whether the second screen is in a lock screen state.

In some embodiments of the disclosure, when the dual-screen device detects the display instruction, the second screen may be in the lock screen state, or may be in an unlocked state. At this time, the dual-screen device can first detect whether the second screen is in the lock screen state, and then display the target image on the second screen in different ways according to a detected screen state of the second screen. In some embodiments, the dual-screen device performs an operation 204 in response to the second screen being in a lock screen state; and performs an operation 205 in response to the second screen being not in a lock screen state.

Operation 204: displaying the target image in a lock screen page of the second screen.

When it is detected that the second screen is in the lock screen state, the dual-screen device can display the target image directly in the lock screen page of the second screen. For example, it can set the target image as a lock screen image of the second screen, to ensure that the second screen can still display the target image for a long time when being in the lock screen state again after it is unlocked.

For example, as illustrated in FIG. 2E, when detecting that the second screen 02 is in the lock screen state, the dual-screen device can display the target image containing a two-dimensional code directly in the lock screen page of the second screen, so that the user can perform the ticket verification through the target image containing the two-dimensional code.

It shall be noted that the dual-screen device can further add a new page in the second screen and set an image currently being displayed on the added new page as the target image, when displaying the target image in the lock screen page of the second screen. In some embodiments of the disclosure, the second screen of the dual-screen device can include a plurality of pages, and the user can switch pages of the second screen to display differently by performing a sliding operation on the second screen.

In further embodiments, the dual-screen device can further set the added new page as the first page of the plurality of pages, and the first page is a page displayed by the second screen of the dual-screen device after the second screen is started up and unlocked.

Operation 205: displaying the target image in a current display page of the second screen and setting the target image as a lock screen image of the second screen.

When the dual-screen device detects the display instruction, the dual-screen device can refresh the second screen to update the current display page of the second screen with the target image, and simultaneously set the target image as the lock screen image of the second screen, when it is detected that the second screen is not in the lock screen state, to ensure that the second screen can still display the target image for a long time when it is in the lock screen state.

In some embodiments, the dual-screen device can further add a new page in the second screen, display the target image in the added new page, and set the target image as the lock screen image of the second screen. Moreover, the dual-screen device can further take the added new page as the first page of the second screen to display.

For one example, the second screen can include three pages, the second screen is not in the lock screen state currently, the displayed page on the second screen is a preset main page, and an electronic book is displayed on the main page. In this example the dual-screen device can add a fourth page in the second screen, display the target image in the fourth page, and set the target image as the lock screen image of the second screen. When a time period when the second screen is not operated exceeds a preset time period, the second screen enters into the lock screen state, and at this time, the target image can be displayed in the lock screen page of the second screen, thereby realizing a long-time display of the target image. Here, the preset time period can be configured by the dual-screen device in advance, or can be set by the user.

It shall be noted that, in a scenario where the second screen is refreshed to update the current display page of the second screen with the target image, in order to make the user aware of a position of a page where the target image is located to facilitate the use of the target image by the user, the page where the target image is located can be displayed directly on the second screen when the dual-screen device unlocks the second screen for the first time or returns to a home screen of the second screen for the first time after refreshing the second screen to update the current display page of the second screen with the target image. And the second screen can display a page, displayed before the previous screen locking, when the dual-screen device unlocks the second screen every time later; or the second screen can display a preset first page of a plurality of pages of the second screen when the dual-screen device returns to the first page of the second screen every time later. The user can cause the second screen of the dual-screen device to display the page where the target image is located by performing certain operations such as sliding or clicking.

In a scenario where the new page is added in the second screen, in order to make the user be aware of a position where the new page is located to facilitate the use of the target image displayed on the new page by the user, the new page can be displayed directly on the second screen when the dual-screen device unlocks the second screen for the first time or returns to the home screen of the second screen for the first time after adding the new page. And the second screen can display a page, displayed before the previous screen locking, when the dual-screen device unlocks the second screen every time later; or the second screen can display a preset first page of a plurality of pages of the second screen when the dual-screen device returns to the first page of the second screen every time later. The user can cause the second screen of the dual-screen device to display the new page by performing a sliding operation.

In some embodiments, in order to enable the user to be much more intuitively aware of the position where the new page is located in the plurality of pages of the second screen, a page number prompt icon of the new page is different from page number prompt icons of the other pages. Here, the page number prompt icon is generally displayed at the bottom of the display screen, and can be used for indicating the number of pages included by the display screen and the position where the current display page is located.

For one example, it is assumed that a new page is added in the second screen 02 of the dual-screen device and the new page is the first page of the four pages of the second screen, as illustrated in FIG. 2F. The shape of the page number prompt icon 021 of the new page can be pentagonal or star-shaped, and the shapes of the page number prompt icons 022 of the other pages can be circular, i.e. the shape of the page number prompt icon 021 of the new page and the shapes of the page number prompt icons 022 of the other pages are different.

Operation 206: deleting the target image and updating the lock screen image of the second screen with a preset image displayed before the target image upon receiving a preset delete operation for the target image.

When the user does not need the dual-screen device to continue displaying the target image, in order not to influence the normal use of the dual-screen device, the user can perform the preset delete operation for the target image on the second screen, and the dual-screen device can delete the target image after receiving the preset delete operation through the second screen.

In some embodiments, if the dual-screen device adds a new page in the second screen of the dual-screen device and displays the target image in the new page when displaying the target image, the dual-screen device can delete the target image by deleting the new page directly. If the dual-screen device adds no new page and directly refreshes the second screen to update the current display page of the second screen with the target image, the dual-screen device can refresh the second screen to update a page of the second screen where the target image is displayed again when deleting the target image, so that the display image of the page is an image displayed in the page before the target image.

In some embodiments, a delete icon is further displayed in the page of the second screen where the target image is displayed, and the preset delete operation is an operation (e.g., a clicking operation or a long pressing operation or the like) performed on the delete icon. Of course, the preset delete operation can also be the operation of long pressing the blank area of the second screen, the operation of pressing the specified physical button(s) (e.g., simultaneously pressing the power button and the volume button) or the like, which is not limited to the embodiments explicitly described in the disclosure.

For example, as illustrated in FIG. 2F, a delete icon 023 is further displayed in the page of the second screen where the target image is displayed. When one wants to delete the target image, he or she can click the delete icon 023, and the dual-screen device can receive the operation of clicking the delete icon 023 through the second screen 02 to thereby delete the target image.

In some embodiments, the dual-screen device can further update the lock screen image of the second screen with a preset image after deleting the target image. In some embodiments, if the lock screen image of the second screen is a specific image configured in advance before the dual-screen device displays the target image, the dual-screen device can update the lock screen image of the second screen with the specific image configured in advance after deleting the target image. If the dual-screen device does not configure the lock screen image of the second screen to a certain specified image in advance (that is, the lock screen image of the second screen is an image displayed before the screen locking) before displaying the target image, a lock screen interface of the second screen can continue displaying the image displayed before the screen locking when the second screen of the dual-screen device is in the lock screen state after the target image is deleted.

In some embodiments of the disclosure, the dual-screen device can further store the target image into a private folder preset in the shared memory, where a plurality of target images can be stored in the private folder and the plurality of target images can be stored according to a sequential order of the obtaining time. After the dual-screen device deletes some target image according to a received preset delete operation, the dual-screen device can further preserve the original data of the target image in the private folder so that the target image can be resumed if needed.

Further, when the dual-screen device restarts, the dual-screen device can display a target image stored recently on the second screen if the dual-screen device does not receive the preset delete operation for the target image before shutdown.

In conclusion, the embodiments of the disclosure provide image display methods of the dual-screen device, where the dual-screen device can obtain the target image according to the detected display instruction, and display the target image directly in the lock screen page of the second screen when the second screen is in the lock screen state; and display the target image in the current display page of the second screen and set the target image as the lock screen image of the second screen when the second screen is not in the lock screen state. Since the second screen is the c-ink screen which can reflect the light rays, it can be ensured that the target image can be displayed naturally under any light condition, thus the power consumption of the dual-screen device is reduced effectively, and there is no need for the user to illuminate the first screen repeatedly, which allows the user to show the target image on the e-ink screen conveniently. In addition, most users are used to inputting instructions on the first screen and face the first screen. In order to scan the image showing on the first screen with a scanning device, the users need to manually move the mobile device to allow the image showing on the first screen to face the scanning device. The methods provided in this disclosure allow the image showing on the first screen to display on the second screen, thereby being scanned by the scanning device which is usually facing a side opposite the first screen. Therefore, there is no need for the users to manually move their mobile device to allow the scanning device to scan the image on the first screen. An instruction input on the first screen allows the mobile device to show the target image on the second screen to avoid repeated operations on the first screen, thereby making it easier for the user to show the target image to the scanning device.

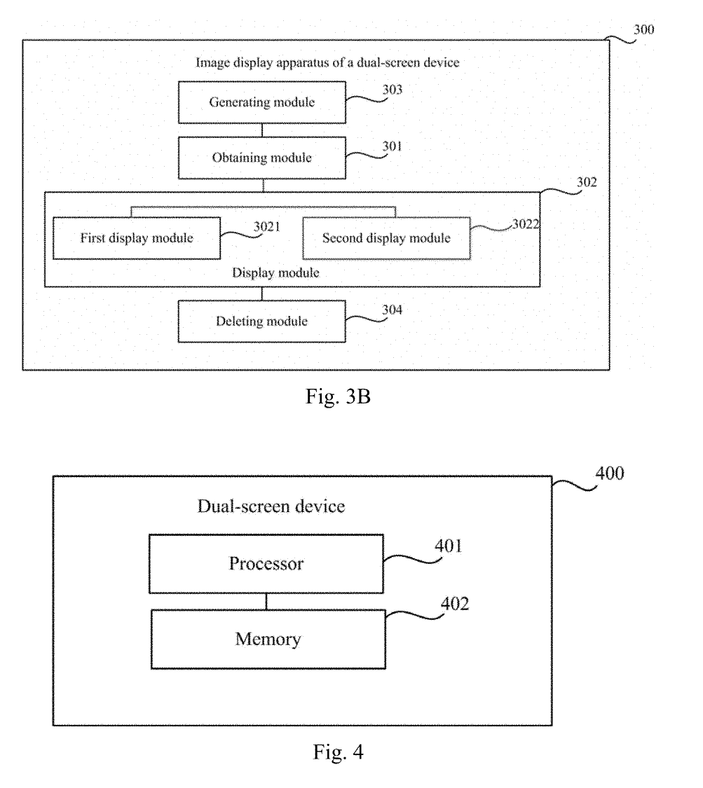

The embodiments of the disclosure further provide an image display apparatus of a dual-screen device, and FIG. 3A is a block diagram of the image display apparatus 300 of the dual-screen device according to the embodiments of the disclosure, where the dual-screen device includes a first screen and a second screen which is an e-ink screen and arranged opposite to the first screen. As illustrated in FIG. 3A, the image display apparatus 300 of the dual-screen device includes: an obtaining module 301 configured to obtain a target image currently being displayed on the first screen upon detecting a display instruction for displaying an image on the second screen; and a display module 302 configured to display the target image on the second screen.

In conclusion, the embodiments of the disclosure provide image display apparatuses of the dual-screen device, which can obtain the target image according to the detected display instruction and display the target image on the second screen. Since the second screen can be the e-ink screen which can reflect the light rays, it can be ensured that the target image can be displayed naturally under any light condition, thus the power consumption of the dual-screen device is reduced effectively, and there is no need for the user to illuminate the first screen repeatedly, which allows the user to show the target image on the e-ink screen conveniently. In addition, most users are used to inputting instructions on the first screen and face the first screen. In order to scan the image showing on the first screen with a scanning device, the users need to manually move the mobile device to allow the image showing on the first screen to face the scanning device. The apparatus provided in this disclosure allows the image showing on the first screen to display on the second screen, thereby being scanned by the scanning device which is usually facing a side opposite the first screen. Therefore, there is no need for the users to manually move their mobile device to allow the scanning device to scan the image on the first screen. An instruction input on the first screen allows the mobile device to show the target image on the second screen to avoid repeated operations on the first screen, thereby making it easier for the user to show the target image to the scanning device.

In some embodiments, as illustrated in FIG. 3B, which is another schematic structural diagram of the image display apparatus 300 of the dual-screen device according to the embodiments of the disclosure, the display module 302 includes: a first display module 3021 configured to display the target image in a lock screen page of the second screen in response to the second screen being in a lock screen state; and a second display module 3022 configured to display the target image in a current display page of the second screen and to set the target image as a lock screen image of the second screen, in response to the second screen being not in the lock screen state.

In some embodiments, the second display module 3022 is configured to: refresh the second screen to update the current display page of the second screen with the target image; or add a new page in the second screen, and display the target image in the new page.

In some embodiments, as illustrated in FIG. 3B, the image display apparatus 300 of the dual-screen device further includes a generating module 303 configured to: generate the display instruction upon receiving a preset display operation on the first screen; or generate the display instruction upon detecting that the first screen switches from an awake state to a screen-off state due to non-operation.

In some embodiments, the generating module 303 is configured to: receive a screen capture operation via the first screen; display a prompt message on the first screen according to the screen capture operation, wherein the prompt message is used for indicating whether a captured image needs to be displayed on the second screen; receive an input in response to the prompt message via the first screen; and generate the display instruction according to the input in response to the prompt message.

In some embodiments, the generating module 303 is configured to: determine whether there is a target image, which includes a two-dimensional code or a bar code, presented on the first screen or not; and upon detecting that the first screen switches from the awake state to the screen-off state due to non-operation, generate the display instruction in response to the two-dimensional code or the bar code being presented on the first screen.

In some embodiments, the generating module 303 is configured to: generate the display instruction upon detecting a two-dimensional code or a bar code presented on the first screen.

In some embodiments, as illustrated in FIG. 3B, the image display apparatus 300 of the dual-screen device further includes a deleting module 304 configured to: delete the target image and update the lock screen image of the second screen with a preset image displayed before the target image upon receiving a preset delete operation for the target image.

As can be understood clearly by those skilled in the art, for the convenience and simplicity of description, the working processes of the above-mentioned devices and modules can refer to the corresponding processes in the method embodiments described above, and the detailed description thereof will be omitted here.

The embodiments of the disclosure further provide a dual-screen device, and as illustrated in FIG. 4, the dual-screen device 400 can include a first screen (not illustrated), a second screen (not illustrated) which can be an e-ink screen arranged opposite to the first screen, and a processor 401 and a memory 402 storing computer programs, where the processor 401 is configured to execute the computer programs to: obtain a target image currently being displayed on the first screen upon detecting a display instruction for displaying an image on the second screen; and display the target image on the second screen.

In some embodiments, the processor 401 is further configured to execute the computer programs to: display the target image in a lock screen page of the second screen in response to the second screen being in a lock screen state.

In some embodiments, the processor 401 is further configured to execute the computer programs to: display the target image in a current display page of the second screen and set the target image as a lock screen image of the second screen, in response to the second screen being not in the lock screen state.

In some embodiments, the processor 401 is further configured to execute the computer programs to: refresh the second screen to update the current display page of the second screen with the target image; or add a new page in the second screen, and display the target image in the new page.

In some embodiments, the processor 401 is further configured to execute the computer programs to: generate the display instruction upon receiving a preset display operation on the first screen; or generate the display instruction upon detecting that the first screen switches from an awake state to a screen-off state due to non-operation.

In some embodiments, the processor 401 is further configured to execute the computer programs to: receive a screen capture operation via the first screen; display a prompt message on the first screen according to the screen capture operation, wherein the prompt message is used for indicating whether a captured image needs to be displayed on the second screen; receive an input in response to the prompt message via the first screen; and generate the display instruction according to the input in response to the prompt message.

In some embodiments, the processor 401 is further configured to execute the computer programs to: determine whether there is a target image, which includes a two-dimensional code or a bar code, presented on the first screen or not upon detecting that the first screen switches from the awake state to the screen-off state due to non-operation; and generate the display instruction in response to the two-dimensional code or the bar code being presented on the first screen.

In some embodiments, the processor 401 is further configured to execute the computer programs to: generate the display instruction upon detecting a two-dimensional code or a bar code presented on the first screen.

In some embodiments, the processor 401 is further configured to execute the computer programs to: delete the target image and update the lock screen image of the second screen with a preset image displayed before the target image upon receiving a preset delete operation for the target image.

The embodiments of the disclosure further provide a computer readable non-transitory storage medium comprising program codes, where the program codes are configured to enable a processor of a dual-screen device to execute operations of the image display methods according to the embodiments of the disclosure when the program codes run on the processor, where the dual-screen device includes a first screen and a second screen which can be an e-ink screen and arranged opposite to the first screen.

The embodiments of the disclosure further provide a computer program product including instructions, where the computer program product is configured to enable a computer to execute operations of the image display methods according to the embodiments of the disclosure when the computer program product runs on the computer.

The disclosure has been described above by reference to the block diagrams and/or flow charts showing the methods, devices (systems) and/or computer program products according to the embodiments of the disclosure. It should be understood that one block illustrated in the block diagrams and/or flow charts and a combination of the blocks illustrated in the block diagrams and/or flow charts can be implemented by the computer program instructions. These computer program instructions can be provided to a general-purpose computer, a processor of a dedicated computer and/or another programmable data processing unit to produce a machine, so that the instructions executed by the computer processor and/or another programmable data processing unit create the methods for implementing the functions and/or actions specified in the blocks of the block diagrams and/or flow charts.

Accordingly, the disclosure can also be implemented by the hardware and/or software (including the firmware, resident software, microcode and the like). Further, the disclosure can adopt the form of computer program products on the computer usable or computer readable storage medium, which has the computer usable or computer readable program codes implemented in the medium, to be used by the instruction execution system or used in combination with the instruction execution system. In the context of the disclosure, the computer usable or computer readable storage medium can be any medium, which can contain, store, communicate with, transmit or transfer the programs, to be used by the instruction execution system, apparatus or device, or used in combination with the instruction execution system, apparatus or device.

Evidently those skilled in the art can make various modifications and variations to the disclosure without departing from the spirit and scope of the disclosure. Thus the disclosure is also intended to encompass these modifications and variations to the disclosure as long as these modifications and variations come into the scope of the claims of the disclosure and their equivalents.

1. An image display method of a dual-screen device comprising a first screen and a second screen which is an e-ink screen and arranged opposite to the first screen, the method comprising:
upon detecting a display instruction for displaying an image on the second screen, obtaining a target image currently being displayed on the first screen; and
displaying the target image on the second screen.

2. The method according to claim 1, wherein displaying the target image on the second screen comprises:
in response to the second screen being in a lock screen state, displaying the target image in a lock screen page of the second screen.

3. The method according to claim 1, wherein displaying the target image on the second screen comprises:
in response to the second screen being not in a lock screen state, displaying the target image in a current display page of the second screen and setting the target image as a lock screen image of the second screen.

4. The method according to claim 3, wherein displaying the target image in the current display page of the second screen comprises:
refreshing the second screen to update the current display page of the second screen with the target image; or
adding a new page in the second screen, and displaying the target image in the new page.

5. The method according to claim 1, wherein before detecting the display instruction, the method further comprises:
generating the display instruction upon receiving a preset display operation on the first screen; or
generating the display instruction upon detecting that the first screen switches from an awake state to a screen-off state due to non-operation.

6. The method according to claim 5, wherein generating the display instruction upon receiving the preset display operation on the first screen comprises:
receiving a screen capture operation via the first screen;
displaying a prompt message on the first screen according to the screen capture operation, wherein the prompt message is used for indicating whether a captured image needs to be displayed on the second screen;
receiving an input in response to the prompt message via the first screen; and
generating the display instruction according to the input in response to the prompt message.

7. The method according to claim 5, wherein generating the display instruction upon detecting that the first screen switches from the awake state to the screen-off state due to non-operation comprises:
determining whether there is a target image, which comprises a two-dimensional code or a bar code, presented on the first screen or not upon detecting that the first screen switches from the awake state to the screen-off state under the due to non-operation; and
generating the display instruction in response to the two-dimensional code or the bar code being presented on the first screen.

8. The method according to claim 1, wherein before detecting the display instruction, the method further comprises:
generating the display instruction upon detecting a two-dimensional code or a bar code presented on the first screen.

9. The method according to claim 3, wherein after displaying the target image in the current display page of the second screen and setting the target image as the lock screen image of the second screen, the method further comprises:
deleting the target image and updating the lock screen image of the second screen with a preset image displayed before the target image upon receiving a preset delete operation for the target image.

10. A dual-screen device comprising a first screen, a second screen which is an e-ink screen and arranged opposite to the first screen, and a processor and a memory storing computer programs; wherein the processor is configured to execute the computer programs to:
obtain a target image currently being displayed on the first screen upon detecting a display instruction for displaying an image on the second screen; and
display the target image on the second screen.

11. The dual-screen device according to claim 10, wherein the processor is further configured to execute the computer programs to:
display the target image in a lock screen page of the second screen in response to the second screen being in a lock screen state.

12. The dual-screen device according to claim 10, wherein the processor is further configured to execute the computer programs to:
display the target image in a current display page of the second screen and set the target image as a lock screen image of the second screen, in response to the second screen being not in a lock screen state.

13. The dual-screen device according to claim 12, wherein the processor is further configured to execute the computer programs to:
refresh the second screen to update the current display page of the second screen with the target image; or
add a new page in the second screen, and display the target image in the new page.

14. The dual-screen device according to claim 10, wherein the processor is further configured to execute the computer programs to:
generate the display instruction upon receiving a preset display operation on the first screen; or
generate the display instruction upon detecting that the first screen switches from an awake state to a screen-off state due to non-operation.

15. The dual-screen device according to claim 14, wherein the processor is further configured to execute the computer programs to:
receive a screen capture operation via the first screen;
display a prompt message on the first screen according to the screen capture operation, wherein the prompt message is used for indicating whether a captured image needs to be displayed on the second screen;
receive an input in response to the prompt message via the first screen; and
generate the display instruction according to the input in response to the prompt message.

16. The dual-screen device according to claim 14, wherein the processor is further configured to execute the computer programs to:
determine whether there is a target image, which comprises a two-dimensional code or a bar code, presented on the first screen or not upon detecting that the first screen switches from the awake state to the screen-off state due to non-operation; and
generate the display instruction in response to the two-dimensional code or the bar code being presented on the first screen.

17. The dual-screen device according to claim 10, wherein the processor is further configured to execute the computer programs to:
generate the display instruction upon detecting a two-dimensional code or a bar code presented on the first screen.

18. The dual-screen device according to claim 12, wherein the processor is further configured to execute the computer programs to:
delete the target image and update the lock screen image of the second screen with a preset image displayed before the target image upon receiving a preset delete operation for the target image.

19. A computer readable non-transitory storage medium comprising program codes, wherein the program codes are configured to enable a processor of the dual-screen device to execute operations of the method according to claim 1 when the program codes run on the processor.
